(19) United States
(12) Patent Application Publication
(10) Pub. No.: US 2023/0053123 A1
(43) Pub. Date: Feb. 16, 2023

(54) ELECTRONIC SHELF LABEL AND CONTROLLING METHOD THEREOF

(71) Applicant: RAINUS CO., LTD., Seongnam-si, Gyeonggi-do (KR)

(72) Inventors: Jong Woo SUNG, Seongnam-si, Gyeonggi-do (KR); Hyun-Hak KIM, Seongnam-si, Gyeonggi-do (KR)

(21) Appl. No.: 17/789,864

(22) PCT Filed: Sep. 25, 2020
(86) PCT No.: PCT/KR2020/013047

§ 371 Date: Jun. 29, 2022

(30) Foreign Application Priority Data
May 21, 2020 (KR) 10-2020-0061084

(51) Int. Cl. G06Q 30/06

(52) U.S. Cl. CPC G06Q 30/0601

(57) ABSTRACT

According to an embodiment of the present disclosure, an electronic shelf label includes a display configured to receive a touch input from a user and display information to the user on a screen; and a controller configured to control the screen displayed by the display based on the input received through the display, the display is configured to receive a division input from the user, and the controller is configured to determine type of division input, generate a plurality of virtual cells by dividing the screen based on the determination result thereof, and assign a unique code to each of the plurality of virtual cells.

### TECHNICAL FIELD

The present disclosure relates to an electronic shelf label and a controlling method thereof, and more particularly, to a method for controlling an electronic shelf label that may divide into virtual cells displayed on the electronic shelf label using various methods.

### BACKGROUND ART

A large number of products on sale are displayed on a display stand in stores such as large marts. A label of recording product information such as product name, product price, and product shelf-life is attached to the display stand, and customers may identify the product information by checking the label.

The displayed products are sold within a short time period in stores where products are quickly distributed, so the product information displayed on the label may be frequently changed. Therefore, an electronic shelf label (ESL) is widely used in stores to easily change the product information displayed on the label and to repeatedly use.

The ESL receives and displays various pieces of product information including price information. The ESL is a substitute for other paper labels and may display product information.

FIG. 1 shows a conventional ESL used to display product information on product displayed on a display stand of a store.

Referring to FIG. 1, it may be seen that a plurality of ESLs 10 are used to display product information on a plurality of products displayed on the display stand. In order to display the product information on the ESL 10 as described above, a store manager may place the ESL 10 according to the position of the product displayed on the display stand and map the individual ESL 10 to the displayed product using a terminal device 20 such as a PDA. Specifically, a process of storing mapping information in a management server 30 by reading the unique number of the ESL 10 and an identification code of the product to be mapped by the terminal device 20 using means such as a barcode or NFC is performed. Subsequently, the ESL 10 receives the information on the mapped product from the management server 30 and displays the product information.

The manager has to map the individual ESL 10 to the product while carrying the terminal device 20 to display the product information using the ESL 10 as described above. If an abnormality occurs in the terminal device 20, there is a problem in that the product information to be displayed on the ESL 10 may not be set.

In addition, the manager has to arrange a different number of ESLs 10 according to the number of types of products displayed on a display stand. That is, as the number of types of products displayed on the display stand is changed, the manager experiences inconvenience of having to change the number of ESLs 10 arranged on the display stand.

### DISCLOSURE

### Technical Problem

The present disclosure provides an electronic shelf label that may divide into virtual cells using various methods by a manager to display product information on a plurality of products using an electronic shelf label and a method for controlling the electronic shelf label.

The present disclosure also provides an electronic shelf label that may divide into the virtual cells to have a boundary at a position desired by the manager and a method for controlling the electronic shelf label.

The present disclosure further provides an electronic shelf label that may easily manage a plurality of divided virtual cells using a unique code and a method for controlling the electronic shelf label.

The objects of the present disclosure are not limited to the above-mentioned objects, and other objects and advantages of the present disclosure that are not mentioned may be understood by the following description, and will be more clearly understood by embodiments of the present disclosure. In addition, it will be easily understood that the objects and advantages of the present disclosure may be realized by features described in claims and a combination thereof.

### Technical Solution

According to an embodiment of the present disclosure, an electronic shelf label include a display configured to receive a touch input from a user and display information to the user on a screen; and a controller configured to control the screen displayed by the display based on the input received through the display, the display is configured to receive a division input from the user, and the controller is configured to: determine the type of division input, generate a plurality of virtual cells by dividing the screen based on the determination result thereof, and assign a unique code to each of the plurality of virtual cells.

In addition, according to an embodiment of the present disclosure, for the electronic shelf label, the controller is configured to: based on determination that the division input is a touch input connecting any area of a first side of the display to any area of a second side of the display, generate virtual cells having a boundary at an area where the division input is received.

In addition, according to an embodiment of the present disclosure, for the electronic shelf label, the controller is configured to: based on a distance between any area of the first side of the display and any area of the second side of the display being less than or equal to a preset reference distance, generate the virtual cells having the boundary at the area where the division input is received.

In addition, according to an embodiment of the present disclosure, for the electronic shelf label, the controller is configured to: based on determination that the division input is two or more consecutive touch inputs, generate virtual cells having the number corresponding to the number of consecutive touch inputs.

In addition, according to an embodiment of the present disclosure, for the electronic shelf label, the controller is configured to: based on reception of a virtual keypad display input from the user before the display receives the division input from the user, control the display to display a virtual keypad and based on determination that the division input is a number input using the virtual keypad, generate virtual cells having the number corresponding to the number of number inputs.

In addition, according to an embodiment of the present disclosure, for the electronic shelf label, the controller is configured to: based on reception of a template set input from the user before the display receives the division input from the user, control the display to display a template list and based on determination that the division input is a template selection input, generate a virtual cell based on the template selection input.

In addition, according to an embodiment of the present disclosure, for the electronic shelf label, the controller is configured to: based on the display receiving the template set input from the user, transmit the template set input to a management server and receive the template list from the management server.

In addition, according to an embodiment of the present disclosure, for the electronic shelf label, the controller is configured to: based on the determination that the division input is the template selection input, transmit the template selection input to a management server and receive virtual cell information corresponding to the template selection input from the management server.

In addition, according to an embodiment of the present disclosure, the electronic shelf label further includes a microphone configured to receive a voice input from the user, the controller is configured to: based on determination that the division input is a voice division input to the microphone, generate a virtual cell based on the voice division input.

In addition, according to an embodiment of the present disclosure, for the electronic shelf label, the controller is configured to control to display the unique code assigned to each of the plurality of virtual cells.

In addition, according to an embodiment of the present disclosure, a method for controlling an electronic shelf label includes: receiving, at the display, a division input from the user; determining, by the controller, a type of division input; generating, by the controller, a plurality of virtual cells by dividing the screen based on a determination result thereof; and assigning, by the controller, a unique code to each of the plurality of virtual cells.

In addition, according to an embodiment of the present disclosure, for the method, generating the plurality of virtual cells includes: based on determination that the division input is the touch input connecting any area of a first side of the display to any area of a second side of the display, generating, by the controller, virtual cells having a boundary at an area where the division input is received.

In addition, according to an embodiment of the present disclosure, for the method, generating the plurality of virtual cells includes: based on a distance between any area of the first side of the display and any area of the second side of the display being less than or equal to a preset reference distance, generating, by the controller, the virtual cells having the boundary at the area where the division input is received.

In addition, according to an embodiment of the present disclosure, for the method, generating the plurality of virtual cells includes: based on determination that the division input is two or more consecutive touch inputs, generating, by the controller, virtual cells having the number corresponding to the number of consecutive touch inputs.

In addition, according to an embodiment of the present disclosure, the method further includes controlling, by the controller, the display to display a virtual keypad based on the display receiving a virtual keypad display input from the user before receiving the division input from the user, and generating the plurality of virtual cells includes generating, by the controller, virtual cells having the number corresponding to the number of number inputs based on determination that the division input is a number input using the virtual keypad.

In addition, according to an embodiment of the present disclosure, the method further includes displaying, by the controller, a template list on the display based on the display receiving a template set input from the user before receiving the division input from the user, and generating the plurality of virtual cells includes generating: based on determination that the division input is a template selection input, by the controller, a virtual cell based on the template selection input.

In addition, according to an embodiment of the present disclosure, for the method, displaying, by the controller, the template list on the display includes: transmitting, by the controller, the template set input to a management server; and receiving, by the controller, the template list from the management server.

In addition, according to an embodiment of the present disclosure, for the method, generating the plurality of virtual cells includes: transmitting, by the controller, the template selection input to a management server based on the determination that the division input is the template selection input; and receiving, by the controller, virtual cell information corresponding to the template selection input from the management server.

In addition, according to an embodiment of the present disclosure, for the method, generating the plurality of virtual cells includes generating, based on determination the division input is a voice division input to the microphone, by the controller, the virtual cell based on the voice division input.

In addition, according to an embodiment of the present disclosure, the method further includes controlling, by the controller, to display the unique code assigned to each of the plurality of virtual cells.

### Advantageous Effects

A manager may divide into virtual cells by various methods using an electronic shelf label and a method for controlling the electronic shelf label according to the present disclosure.

In addition, the manager may generate virtual cells having a boundary at a position desired by the manager and with the number desired by the manager using the electronic shelf label and the method for controlling the electronic shelf label according to the present disclosure.

In addition, the manager may easily manage a plurality of divided virtual cells using a unique code by the electronic shelf label and with the method for controlling the electronic shelf label according to the present disclosure.

In addition to the above-described effects, further effects of the present disclosure are described together with explanations of specific matters to implement the present disclosure.

### DESCRIPTION OF DRAWINGS

FIG. 1 shows a conventional electronic shelf label used to display product information of products displayed on a display stand of a store.

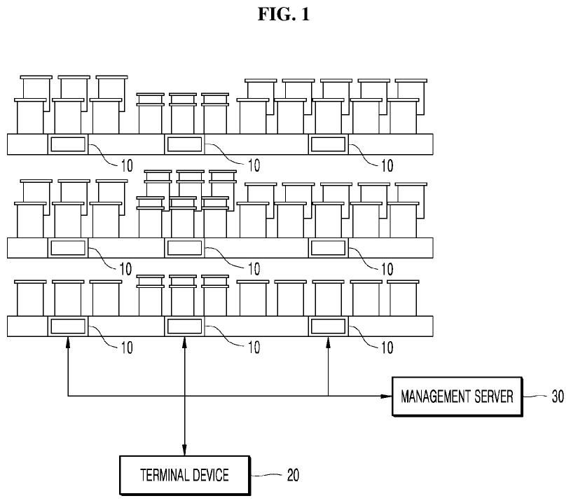

FIG. 2 shows an electronic shelf label according to an embodiment of the present disclosure.

FIG. 3 is a flowchart of a method for controlling an electronic shelf label according to an embodiment of the present disclosure.

FIG. 4 shows a method for dividing into virtual cells if a division input is a touch input connecting any area of a first side of a display to any area of a second side of the display in a method for controlling an electronic shelf label according to an embodiment of the present disclosure.

FIG. 5 shows a method for dividing into virtual cells if a division input is two or more consecutive touch inputs in a method for controlling an electronic shelf label according to an embodiment of the present disclosure.

FIG. 6 shows a method for dividing into virtual cells if a division input is a number input using a virtual keypad in a method for controlling an electronic shelf label according to an embodiment of the present disclosure.

FIG. 7 shows a method for dividing into virtual cells if a division input is a template selection input in a method for controlling an electronic shelf label according to an embodiment of the present disclosure.

### BEST MODE

The above-mentioned objects, features, and advantages of the present disclosure are described in detail with reference to accompanying drawings. Therefore, the skilled person in the art to which the present disclosure pertains may easily embody the technical idea of the present disclosure. In the description of the present disclosure, a detailed description of a well-known technology relating to the present disclosure may be omitted if it unnecessarily obscures the gist of the present disclosure. Hereinafter, preferred embodiments of the present disclosure are described in detail with reference to the accompanying drawings. In the drawings, same reference numerals are used to refer to same or similar components.

Terms such as first, second, and the like may be used herein to describe various elements of the present disclosure. These elements are not limited by these terms. These terms are intended to distinguish one element from another element. A first element may be a second element unless otherwise stated.

Further, the terms “connected,” “coupled,” or the like are used such that, where a first component is connected or coupled to a second component, the first component may be directly connected or able to be connected to the second component, or one or more additional components may be disposed between the first and second components, or the first and second components may be connected or coupled through one or more additional components.

Singular expressions used in the present disclosure include plural expressions unless the context clearly displays otherwise. In the present disclosure, terms such as “including” or “comprising” should not be construed as necessarily including all of the various components, or various steps described in the present disclosure, and terms such as “including” or “comprising” should be construed as not including some elements or some steps or further including additional elements or steps.

Unless otherwise stated, each component may be singular or plural throughout the disclosure.

Hereinafter, an electronic shelf label according to some embodiments of the present disclosure and a method for controlling the electronic shelf label are described.

Hereinafter, a user refers to any person using the electronic shelf label. In addition, a manager refers to a person using the electronic shelf label to manage products sold in the store among users and a consumer refers to a person using the electronic shelf label to obtain product information or purchase products in a store among users.

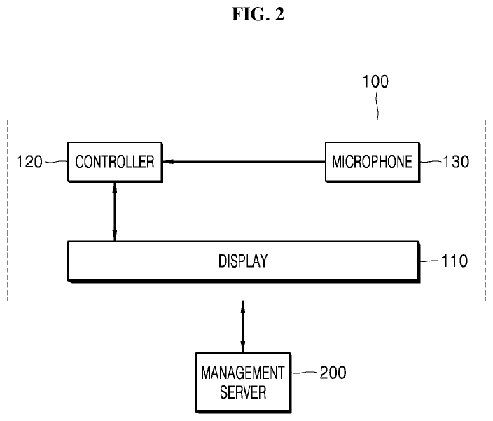

FIG. 2 shows an electronic shelf label according to an embodiment of the present disclosure.

Referring to FIG. 2, an electronic shelf label 100 according to an embodiment of the present disclosure includes a display 110 and a controller 120. In addition, according to an embodiment of the present disclosure, the electronic shelf label 100 may further include a microphone 130.

According to an embodiment of the present disclosure, the electronic shelf label 100 may have a bar shape and a horizontal length thereof is longer than a vertical length thereof when the electronic shelf label 100 is coupled to a display stand. With this bar shape of the electronic shelf label 100, an electronic shelf label 100 may display product information on a plurality of products.

The display 110 receives touch input from a user and displays information to the user on a screen. That is, the display 110 receives the touch input from the user, transmits the touch input to the controller 120, and displays the information to the user according to a command received from the controller 120. The display may display information to the user on one or more virtual cells.

In an embodiment of the present disclosure, the display 110 may be a touch screen capable of displaying information to the user on the screen while receiving the touch input from the user.

The controller 120 controls the screen displayed by the display 110 based on the input received through the display 110. The controller 120 may include a memory to store instructions for controlling the screen displayed by the display 110 based on the input received through the display 110, a processor to process the instructions stored in the memory, and a communication module to communicate with a management server 200 described below.

The controller 120 may control the display 110 to be operated in a consumer mode or a manager mode.

The consumer mode is a mode in which product information is displayed to the consumer. When the electronic shelf label 100 is operated in the consumer mode, the controller 120 may control the display 110 to display a different screen according to the input received through the display 110. In addition, when the electronic shelf label 100 is operated in the consumer mode, the controller 120 may transmit data to the management server 200 described below based on the input received through the display 110.

The manager mode is a mode in which the user may set the screen displayed in the consumer mode. When the electronic shelf label is operated in the manager mode, the user applies the input to the display 110 to divide the screen displayed on the display 110 into virtual cells and match the divided virtual cell to the product.

An electronic shelf label and a control method thereof according to an embodiment of the present disclosure described below relate to a method for dividing into virtual cells using various methods by the manager in the manager mode to display information on a plurality of products by an electronic shelf label.

The microphone 130 receives a voice input from a user. The controller 120 may generate a virtual cell based on the voice division input received at the microphone 130.

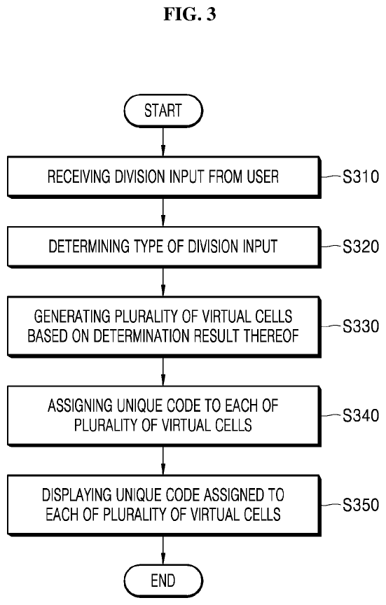

A more detailed method for controlling the electronic shelf label 100 as described above may be described using FIGS. 3 to 7.

FIG. 3 is a flowchart of a method for controlling an electronic shelf label according to an embodiment of the present disclosure.

Referring to FIG. 3, a display 110 receives a division input from a user (S310). The division input is an input including information on how the user divides a screen of the display 110 and may include information on the number or a size of virtual cells to be generated by division.

In an embodiment of the present disclosure, the division input may include at least one of a touch input connecting any area of a first side of the display 110 to any area of a second end of the display 110, two or more consecutive touch inputs, a number input using a virtual keypad, a template selection input, or a voice division input.

After the display 110 receives the division input, a controller 120 determines the type of division input (S320). That is, the controller 120 receives, through the display 101, the division input, which was received from the user, and determines the type of division input.

In one embodiment of the present disclosure, the controller 120 may determine that the division input includes at least one of the touch input connecting any area of the first side of the display 110 to any area of the second side of the display 110, two or more consecutive touch inputs, a number input using the virtual keypad, the template selection input, or the voice division input.

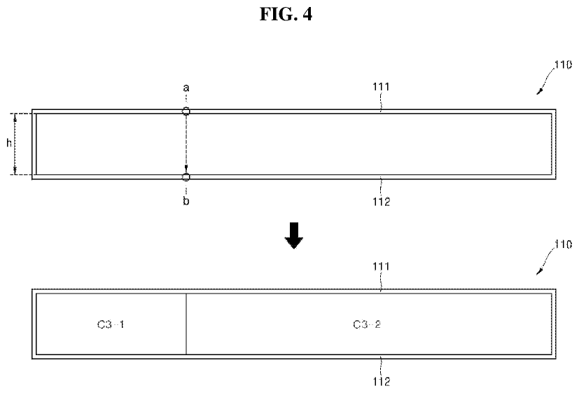

Subsequently, the controller 120 generates a plurality of virtual cells by dividing the screen of the display 110 based on the determination result (S330). A more detailed method for generating, by the controller 120, a plurality of virtual cells based on the result of determining the type of the division input may be described with reference to FIGS. 4 to 7.

FIG. 4 shows a method for dividing into virtual cells based on a division input being a touch input connecting any area of a first side of a display to any area of a second side of a display in a method for controlling an electronic shelf label according to an embodiment of the present disclosure.

Referring to FIG. 4, a display 110 before receiving a division input is shown at an upper portion thereof and a display 110 generating virtual cells based on the division input is shown at a lower portion thereof.

The user may apply a touch input connecting any area of the first end of the display 110 to any area of the second end of the display 110 as a division input. In this case, the first side of the display 110 may be an upper side 111 of the display in the drawing and the second side of the display 110 may be a lower side 112 of the display in the drawing. That is, the user may apply the touch input of connecting any area of the upper side of the display 110 to any area of the lower side of the display 110 as a division input.

By contrast, the first side of the display 110 may be the lower side 112 of the display in the drawing and the second side of the display 110 may be the upper side 111 of the display in the drawing. That is, the user may apply a touch input connecting any area of the lower side of the display 110 to any area of the upper side of the display 110 as a division input.

Based on determination that the division input is a touch input connecting any area of the first side of the display 110 to any area of the second end of the display 110, the controller 120 generates virtual cells having a boundary at an area where the division input is received.

As shown at the upper portion of FIG. 4, the user may apply a touch input connecting area a of the upper side 111 of the display 110 to area b of the second end of the display 110 as a division input. Subsequently, as shown at the lower portion of FIG. 4, the controller 120 may generate the virtual cells with respect to the boundary line connecting the area a to the area b.

In one embodiment of the present disclosure, the controller 120 may generate the virtual cells based on the boundary line passing through a center of a line connecting the area a to the area b and that is perpendicular to each of the upper side 111 and the lower side 112 of the display 110 to generate the virtual cell having a rectangular shape.

In this case, the controller 120 may generate the virtual cells boundary at the area where the division input is received only when a distance between any area of the first side of the display 110 and any area of the second side of the display 110 is less than or equal to a preset reference distance.

The reference distance is a standard of determining whether the touch input connecting any area of the first end of the display 110 to any area of the second side of the display 110 is a division input, which is properly input, and may be set to be slightly larger than a distance (h) between the upper side 111 and the lower side 112 of the display 110. For example, the reference distance may be set to 1.1h, which is greater than the distance (h) between the upper side 111 and the lower side 112 of the display 110 by 10%.

As described above, the controller 120 generates the virtual cells only when the distance between any area of the first side of the display 110 and any area of the second side of the display 110 is less than or equal to the reference distance. Therefore, the controller 120 may not generate virtual cells if the user mistakenly and incorrectly applies a division input.

In addition, the controller may quickly generate virtual cells having a boundary at a desired position by applying a user-touch input connecting any area of the first side of the display 110 to any area of the second side of the display 110.

In this case, the controller 120 generates a plurality of virtual cells, assigns a unique code to each of the plurality of divided virtual cells described below, and may control the unique code to be displayed on each of the plurality of virtual cells as shown at the lower portion of FIG. 4.

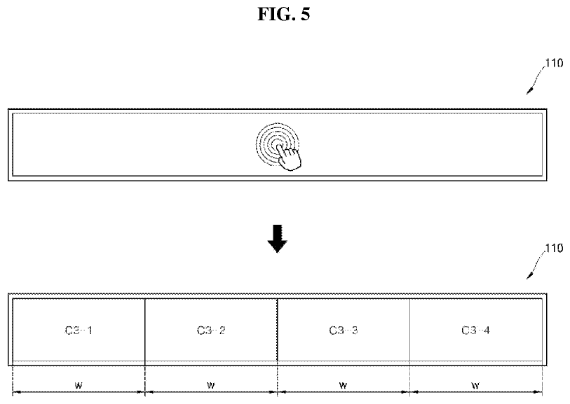

FIG. 5 shows a method for dividing into virtual cells if a division input is two or more consecutive touch inputs in a method for controlling an electronic shelf label according to an embodiment of the present disclosure.

Referring to FIG. 5, a display 110 before receiving the division input is shown at an upper portion thereof and a display 110 in which virtual cells are generated based on the division input is shown at a lower portion thereof.

A user may apply two or more consecutive touch inputs as a division input. That is, the user may apply an input of continuously touching any area of the display 110 two or more times as a division input.

Based on determination that the division input is the two or more consecutive touch inputs, the controller 120 generates virtual cells having the number corresponding to the number of consecutive touch inputs. For example, if the division input is an input of touching the display 110 four times, the controller 120 may generate four virtual cells.

In this case, the controller 120 may generate the virtual cells having the same size. For example, based on receiving four time consecutive touch inputs as a division input, the controller 120 may generate four virtual cells having a same width (w) as shown at the lower portion of FIG. 5.

When the user wants to generate the virtual cells having the same size as described above, the user applies an input of continuously touching any area of the display 110, thereby quickly generating the virtual cells.

In this case, the controller 120 generates a plurality of virtual cells, assigns a unique code to each of the plurality of divided virtual cells as described below, and may control the unique code assigned to each of the plurality of virtual cells to be displayed as shown at the lower portion of FIG. 5.

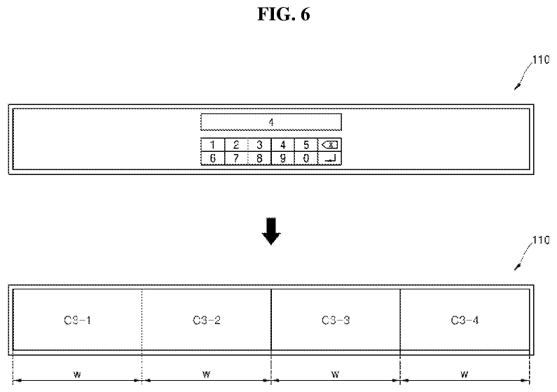

FIG. 6 shows a method for dividing into virtual cells when a division input is a number input using a virtual keypad in a method for controlling an electronic shelf label according to an embodiment of the present disclosure.

Referring to FIG. 6, a display 110 before receiving the division input is shown at an upper portion thereof and a display 110 in which the virtual cells are generated based on the division input is shown at a lower portion thereof.

A virtual keypad and an input confirmation window are displayed on the display 110 at the upper portion of FIG. 6. When the user wants to apply a number input using the virtual keypad as a division input, the user may apply a virtual keypad display input to the display 110 before applying the division input. That is, if the display 110 receives a virtual keypad display input from the user before receiving the division input from the user, the controller 120 may display the virtual keypad on the display 110.

The virtual keypad is a tool that helps the user to input letters and numbers, and the user may input letters or numbers by touching a specific area of the virtual keypad displayed on the display 110. The controller 120 may provide a virtual keypad on the display 110 in order for the user to apply the number input using the virtual keypad.

When the virtual keypad is displayed on the display 110, the controller 120 may receive a number input using the virtual keypad as a division input. In this case, the controller 120 may display the number input by the user on the input confirmation window disposed above the virtual keypad and determine whether the input applied by the user is a correct input.

Based on determination that the division input is the number input using the virtual keypad, the controller 120 generates virtual cells having the number corresponding to the number of number input. For example, if the division input is a number input of 4, the controller 120 may generate four virtual cells.

In this case, the controller 120 may generate the virtual cells having the same size. For example, the controller 120 may generate four virtual cells having a same width (w) as shown at the lower portion of FIG. 6 based on reception of four consecutive touch inputs as the division input.

When the user wants to generate virtual cells having the same size as described above, the user sequentially applies the virtual keypad display input and the number input using the virtual keypad, thereby quickly and accurately generating virtual cells.

In this case, the controller 120 generates the plurality of virtual cells, assigns a unique code to each of the divided virtual cells as described below, and may control the unique code assigned to each of the plurality of virtual cells to be displayed as shown at the lower portion of FIG. 6.

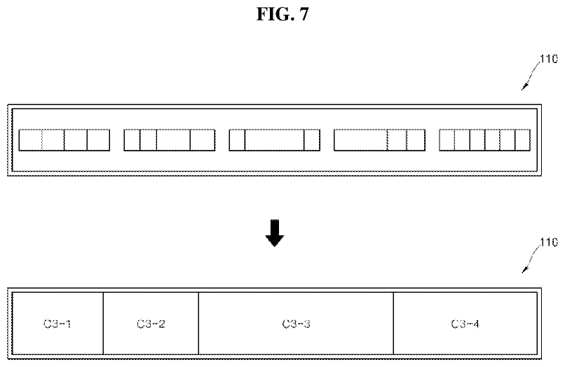

FIG. 7 shows a method for dividing into virtual cells when a division input is a template selection input in a method for controlling an electronic shelf label according to an embodiment of the present disclosure.

Referring to FIG. 7, a display 110 before receiving the division input is shown at an upper portion thereof and a display 110 generating a virtual cell based on the division input is shown at a lower portion thereof.

A list of templates is displayed on the display 110 shown at the upper portion of FIG. 7. The template list includes templates, each template includes divided virtual cells, and may be preset by a user. When the user wants to apply a template selection input of selecting one of the templates included in the template list as a division input, the user may apply a virtual keypad display input to the display 110 before applying a division input. That is, if the display 110 receives a template set input from the user before receiving the division input from the user, the controller 120 may control the display 110 to display the template list.

In this case, the template list may be stored in the management server 200. The controller 120 transmits the template sett input to the management server 200 upon receiving the template set input from the user to receive the template list from the management server 200. In addition, the controller 120 may receive the template list from the management server 200 and control the display 110 to display the template list.

Based on determination that the division input is a template selection input, the controller 120 generates virtual cells based on the template selection input. For example, when the controller 120 receives an input of selecting a template located second from the left among the templates of the display 110 at the upper portion of FIG. 7, the controller 120 may generate virtual cells with the same number and size as the number and size of virtual cells included in the selected template as shown in the display 110 at the lower portion of FIG. 7.

In this case, information on the number and the size of virtual cells of the template selected by the user may be stored in the management server 200. Based on determination that the division input is a template selection input, the controller 120 transmits the template selection input to the management server 200. In addition, the controller 120 may generate virtual cells by receiving virtual cell information including the number and the size of virtual cells based on the template selection input from the management server 200.

When the user wants to generate virtual cells based on a preset template as described above, the virtual cells may be simply generated by sequentially applying a template set input and a template selection input.

In this case, the controller 120 generates a plurality of virtual cells, assigns a unique code to each of the divided virtual cells as described below, and may control the unique code assigned to each of the plurality of virtual cells to be displayed as shown at the lower portion of FIG. 7.

Returning to back to FIG. 3, as described with reference to FIGS. 4 to 7, if the controller 120 receives the touch input connecting any area of the first side of the display 110 to any area of the second side of the display 110, the two or more consecutive touch inputs, a number input using the virtual keypad, or the template selection input as the division input, the controller 120 may generate virtual cells based on the division input.

In addition, when the electronic shelf label 100 further includes a microphone 130 to receive a voice input from the user, the user may apply a voice division input as a division input. That is, the user may apply a voice division input including the number of virtual cells to be generated by voice.

Based on determination that the division input is the voice division input, the controller 120 may generate virtual cells based on the voice division input. For example, if the voice division input is an input in which the number of virtual cells to be generated is four, the controller 120 may generate four virtual cells. In this case, the controller 120 may generate the virtual cells having the same size. For example, the controller 120 may generate four virtual cells having the same width (w) based on reception of a voice division input to generate four virtual cells as the division input.

When the user wants to generate the virtual cells having the same size as described above, the virtual cell may be quickly generated by applying the voice division input to the microphone 130.

After generating the plurality of virtual cells, the controller 120 assigns a unique code to each of the plurality of virtual cells (S340). The unique code distinguishes the generated virtual cells from other virtual cells and may include letters or numbers.

In an embodiment of the present disclosure, the unique code may be arbitrarily set in order not to be identical to the unique code allocated to another virtual cell. In addition, in another embodiment of the present disclosure, the unique code may be generated in consideration of a zone of the display stand on which the electronic shelf label is disposed in the store, the position of the electronic shelf label in the display stand, a sequence of virtual cells, and the like. For example, if the display stand on which the electronic shelf label is disposed is located in zone C of the store, the electronic shelf label is located on the 3rd floor from the top on the display stand, and the virtual cell is on a leftmost side of the electronic shelf label, the unique code may be set as C3-1. The manager may easily manage the plurality of virtual cells using the unique code assigned to each of the plurality of virtual cells as described above.

Subsequently, the display 110 may display the unique code assigned to each of the plurality of virtual cells (S350). In an embodiment of the present disclosure, the unique code may be displayed at a center of each of the plurality of virtual cells, but the present disclosure is not limited thereto.

The manager may divide into the virtual cells by various methods using the electronic shelf label and the method for controlling the electronic shelf label according to the present disclosure as described above. In addition, the electronic shelf label and the method for controlling the electronic shelf label according to the present disclosure may be used to generate virtual cells with the boundary at the position desired by the manager and having the number desired by the manager and.

The present disclosure has been described as described above with reference to exemplary drawings, but the present disclosure is not limited to the embodiments and drawings disclosed herein, and various modifications may be made by those skilled in the art within the scope of the technical idea of the present disclosure. Further, even if working effects obtained based on configurations of the present disclosure are not explicitly described in the description of embodiments of the present disclosure, effects predictable based on the corresponding configuration have to be recognized.

1. An electronic shelf label, comprising:
a display configured to receive a touch input from a user and display information to the user on a screen; and
a controller configured to control the screen displayed by the display based on the input received through the display,
wherein the display is configured to receive a division input from the user, and
wherein the controller is configured to:
determine the type of division input,
generate a plurality of virtual cells by dividing the screen based on the determination result thereof, and
assign a unique code to each of the plurality of virtual cells.

2. The electronic shelf label of claim 1, wherein the controller is configured to: based on determination that the division input is a touch input connecting any area of a first side of the display to any area of a second side of the display, generate virtual cells having a boundary at an area where the division input is received.

3. The electronic shelf label of claim 2, wherein the controller is configured to: based on a distance between any area of the first side of the display and any area of the second side of the display being less than or equal to a preset reference distance, generate the virtual cells having the boundary at the area where the division input is received.

4. The electronic shelf label of claim 1, wherein the controller is configured to: based on determination that the division input is two or more consecutive touch inputs, generate virtual cells having the number corresponding to the number of consecutive touch inputs.

5. The electronic shelf label of claim 1,
wherein the controller is configured to:
based on reception of a virtual keypad display input from the user before the display receives the division input from the user, control the display to display a virtual keypad and
based on determination that the division input is a number input using the virtual keypad, generate virtual cells having the number corresponding to the number of number inputs.

6. The electronic shelf label of claim 1,
wherein the controller is configured to:
based on reception of a template set input from the user before the display receives the division input from the user, control the display to display a template list and
based on determination that the division input is a template selection input, generate a virtual cell based on the template selection input.

7. The electronic shelf label of claim 6, wherein the controller is configured to: based on the display receiving the template set input from the user, transmit the template set input to a management server and receive the template list from the management server.

8. The electronic shelf label of claim 6, wherein the controller is configured to: based on the determination that the division input is the template selection input, transmit the template selection input to a management server and receive virtual cell information corresponding to the template selection input from the management server.

9. The electronic shelf label of claim 1, further comprising a microphone configured to receive a voice input from the user,
wherein the controller is configured to: based on determination that the division input is a voice division input to the microphone, generate a virtual cell based on the voice division input.

10. The electronic shelf label of claim 1, wherein the controller is configured to control to display the unique code assigned to each of the plurality of virtual cells.

11. A method for controlling an electronic shelf label, the electronic shelf label comprising a display configured to receive a touch input from a user and display information to a user on a screen and a controller configured to control the screen displayed by the display based on the input received through the display, the method comprising:
receiving, at the display, a division input from the user;
determining, by the controller, a type of division input;
generating, by the controller, a plurality of virtual cells by dividing the screen based on a determination result thereof; and
assigning, by the controller, a unique code to each of the plurality of virtual cells.

12. The method of claim 11, wherein generating the plurality of virtual cells comprises: based on determination that the division input is the touch input connecting any area of a first side of the display to any area of a second side of the display, generating, by the controller, virtual cells having a boundary at an area where the division input is received.

13. The method of claim 12, wherein generating the plurality of virtual cells comprises: based on a distance between any area of the first side of the display and any area of the second side of the display being less than or equal to a preset reference distance, generating, by the controller, the virtual cells having the boundary at the area where the division input is received.

14. The method of claim 11, wherein generating the plurality of virtual cells comprises: based on determination that the division input is two or more consecutive touch inputs, generating, by the controller, virtual cells having the number corresponding to the number of consecutive touch inputs.

15. The method of claim 11, further comprising controlling, by the controller, the display to display a virtual keypad based on the display receiving a virtual keypad display input from the user before receiving the division input from the user,
wherein generating the plurality of virtual cells comprises generating, by the controller, virtual cells having the number corresponding to the number of number inputs based on determination that the division input is a number input using the virtual keypad.

16. The method of claim 11, further comprising displaying, by the controller, a template list on the display based on the display receiving a template set input from the user before receiving the division input from the user,
wherein generating the plurality of virtual cells comprises generating: based on determination that the division input is a template selection input, by the controller, a virtual cell based on the template selection input.

17. The method of claim 16, wherein displaying, by the controller, the template list on the display comprises:
transmitting, by the controller, the template set input to a management server; and
receiving, by the controller, the template list from the management server.

18. The method of claim 16, wherein generating the plurality of virtual cells comprises:
transmitting, by the controller, the template selection input to a management server based on the determination that the division input is the template selection input; and
receiving, by the controller, virtual cell information corresponding to the template selection input from the management server.

19. The method of claim 11, wherein the electronic shelf label further comprises a microphone configured to receive a voice input from the user,
wherein generating the plurality of virtual cells comprises generating, based on determination the division input is a voice division input to the microphone, by the controller, the virtual cell based on the voice division input.

20. The electronic shelf label of claim 11, further comprising controlling, by the controller, to display the unique code assigned to each of the plurality of virtual cells.
